(19) United States
(12) Patent Application Publication
(10) Pub. No.: US 2023/0146635 A1
(43) Pub. Date: May 11, 2023

(54) Method and Systems for Conditioning Data Sets for Efficient Computational Processing

(71) Applicant: Australia and New Zealand Banking Group Limited, Dockland, Victoria (AU)

(72) Inventor: Warren DU PREEZ, Docklands, Victoria (AU)

(21) Appl. No.: 17/918,747

(22) PCT Filed: Apr. 16, 2021
(86) PCT No.: PCT/AU2021/050342

§ 371 Date: Oct. 13, 2022

(30) Foreign Application Priority Data
Apr. 16, 2020 (AU) 2020901209

(51) Int. Cl. G06N 20/00

(52) U.S. Cl. CPC G06N 20/00

(57) ABSTRACT

Embodiments generally relate to a method for selecting hybrid variables. The method comprises sampling at least one interaction effect structure of at least one multivariable dataset, sampling at least one hybrid variable for each sampled interaction effect structure, calculating a lift value for each sampled hybrid variable, and comparing the lift value to a threshold lift criteria, labeling each sampled hybrid variable based on determining that the lift value of the sample hybrid variable exceeds the threshold lift criteria, training a machine learning model to predict the likelihood of a hybrid variable having a lift which exceeds the threshold lift criteria, applying the trained machine learning model to each hybrid variable within each sampled interaction effect structure to determine a value corresponding to the likelihood of each hybrid variable having a lift which exceeds the threshold lift criteria, and retaining only hybrid variables with a likelihood value that exceeds a decision criteria. The training of the machine learning model is performed using the labeled sampled hybrid variables.

### TECHNICAL FIELD

Described embodiments generally relate to methods and systems for conditioning datasets for computational processing. In particular, described embodiments relate to dataset conditioning for developing supervised classification machine learning models.

### BACKGROUND

Machine learning models are used in a variety of industries to allow for automated decision making to be performed on new datasets. For example, machine learning may be used in financial, economical, industrial or ecological modeling. In machine learning applications, the strength of the models produced depends to a significant degree on the relevance of the data which is used to train the model. To build a strong model will require independent variables which capture as much information about a target as possible. In some models such as logistic regression, the interactivity between independent variables isn't taken into account, thus without some method to force this interactivity, information about the target will be excluded from the model, leading to less effective models.

A useful solution to this issue is to use interaction effects. For example, hybrid variables, a combination of one or more mathematical operations with one or more operands, wherein operands will be variables from a dataset, can force interactivity between variables and then be used as input for training a model. Example mathematical operations include arithmetic operations such as multiplication, division, addition and subtraction; and mathematical functions such as exponential and logarithmic functions, and functions which change order of operations.

However, there are many different interactions possible. For example, for a dataset of 1000 variables for a basic multiplication between two operands, there are 500,500 unique possible interactions of this form. For a multiplication between two operands and then an addition between a third operand, there are 500,500,000 unique possible interactions. Of course, scientists will likely want to consider other combinations of operands and operations, known as hybrid variable structures, outside of the couple aforementioned examples.

Examining all possible interactions will likely not be computationally viable for ordinary modeling datasets, due to excessive latency.

It is desired to address or ameliorate one or more shortcomings or disadvantages associated with prior systems and methods for conditioning data for computational processing of machine learning models in discriminatory problems, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a method for selecting hybrid variables, the method comprising:
sampling at least one interaction effect structure of at least one multivariable dataset;
sampling at least one hybrid variable for each sampled interaction effect structure;
calculating a lift value for each sampled hybrid variable, and comparing the lift value to a threshold lift criteria;
labeling each sampled hybrid variable based on determining that the lift value of the sample hybrid variable exceeds the threshold lift criteria;
training a machine learning model to predict the likelihood of a hybrid variable having a lift which exceeds the threshold lift criteria, the training being performed using the labeled sampled hybrid variables;
applying the trained machine learning model to each hybrid variable within each sampled interaction effect structure to determine a value corresponding to the likelihood of each hybrid variable having a lift which exceeds the threshold lift criteria; and
retaining only hybrid variables with a likelihood value that exceeds a decision criteria.

Some embodiments further comprise:
determining whether the number of retained hybrid variables exceeds a predetermined threshold; and
if the number of the retained hybrid variables does not exceed the predetermined threshold, sampling at least one further interaction effect structure and repeating the method.

Some embodiments further comprise calculating a discriminatory strength statistic for each of the retained hybrid variables, and discarding retained hybrid variables that do not meet a discriminatory strength statistic decision criteria.

In some embodiments the discriminatory strength statistic is a GINI coefficient.

Some embodiments further comprise sorting the retained hybrid variables based on at least one of the discriminatory strength statistic and the predicted lift likelihood value.

In some embodiments sampling at least one hybrid variable for each sampled interaction effect structure comprises sampling so that the number of randomly selected hybrid variables for each sampled interaction effect structure is equal to a multiplicity of the total number of variables contained within the multivariable dataset.

In some embodiments sampling at least one hybrid variable for each sampled interaction effect structure comprises sampling so that the number of randomly selected hybrid variables for each sampled interaction effect structure is at least ten times the total number of variables contained within the multivariable dataset.

In some embodiments the multivariable dataset comprises dependent variables and independent variables.

In some embodiments the dependent variables are labeled variables.

Some embodiments further comprise partitioning the multivariable dataset based on the labeled dependent variables to create at least two partitioned datasets.

Some embodiments further comprise calculating at least one discriminatory strength statistic for each variable in the at least two partitioned datasets, and calculating at least one discriminatory strength statistic for each sampled hybrid variable.

In some embodiments the discriminatory strength statistic comprises a GINI coefficient.

Some embodiments further comprise selecting one or more variables within each hybrid variable, wherein the selected one or more variables comprises a variable with highest discriminatory strength within the hybrid variable.

Some embodiments further comprise calculating moment statistics for each variable, calculating moment statistics for each hybrid variable, and sourcing moment statistics calculated for the selected one or more variables.

In some embodiments calculated moment statics for each variable are used for algebraically calculating moment statistics for each hybrid variable.

In some embodiments the calculated moment statistics for each variable are used as a source for sourcing moment statistics of the selected one or more variables for each hybrid variable.

In some embodiments calculating moment statistics or sourcing moment statistics comprises calculating or sourcing respectively at least the first two moments.

Some embodiments further comprise creating a variable moments dataset and storing the moment statistics of each variable within the variable moments dataset.

Some embodiments further comprise creating a moments dataset and storing the moment statistics of each hybrid variable alongside the moment statistics of the selected one or more variables for the corresponding hybrid variables.

Some embodiments further comprise storing a categorical variable alongside each hybrid variable.

In some embodiments the categorical variable indicates one or more operators of the associated hybrid variable.

In some embodiments the categorical variable comprises at least one of a string variable, a numerical variable, or a one hot encoded as multiple indicator variables.

Some embodiments further comprise calculating a discriminatory measure statistic for each sampled hybrid variable.

In some embodiments the discriminatory measure statistic comprises a GINI coefficient.

In some embodiments calculating a lift value for each sampled hybrid variable comprises dividing the discriminatory measure statistic of the sampled hybrid variable by the discriminatory strength statistic of the variable having the highest discriminatory strength within the hybrid variable.

In some embodiments training the machine learning model to predict the likelihood of a hybrid variable having a lift which exceeds the lift threshold comprises creating a training dataset by combining the labeled sampled hybrid variables with the moments dataset by selecting only matching hybrid variables across the datasets.

In some embodiments each of the at least one interaction effect structures comprises at least one mathematical operator and at least two operands.

In some embodiments each of the at least one hybrid variables comprises at least one operator and at least two operands, the at least two operands of the hybrid variables each comprising a variable from the multivariable dataset.

In some embodiments each of the at least one operator of the at least one interaction effect structures and the at least one hybrid variables comprises an arithmetic operator or mathematical function.

In some embodiments the retained hybrid variables are used for financial, economical, industrial or ecological modeling.

Some embodiments relate to a computer readable medium storing non-transitory instructions which, when executed by a processor, cause the processor to perform any of the aforementioned embodiments and methods.

Some embodiments relate to a system for selecting hybrid variables, the system comprising:
a processor;
memory storing program code that is accessible and executable by the processor; and
wherein, when the processor executed the program code, the processor is caused to:
   sample at least one interaction effect structure of at least one multivariable dataset;
   sample at least one hybrid variable for each sampled interaction effect structure;
   calculate a lift value for each sampled hybrid variable, and comparing the lift value to a threshold lift criteria;
   label each sampled hybrid variable based on determining that the lift value of the sample hybrid variable exceeds the threshold lift criteria;
   train a machine learning model to predict the likelihood of a hybrid variable having a lift which exceeds the threshold lift criteria, the training being performed using the labeled sampled hybrid variables;
   apply the trained machine learning model to each hybrid variable within each sampled interaction effect structure to determine a value corresponding to the likelihood of each hybrid variable having a lift which exceeds the threshold lift criteria; and
   retain only hybrid variables with a likelihood value that exceeds a decision criteria.

Some systems further comprise a user input device, wherein the user input device is configured to receive at least one of the threshold lift criteria and the decision criteria.

In some embodiments the processor is further caused to:
determine whether the number of retained hybrid variables exceeds a predetermined threshold; and
if the number of selected hybrid variables does not exceed the predetermined threshold, sample at least one further interaction effect structure and repeating the method.

In some embodiments the processor is further caused to calculate a discriminatory strength statistic for each retained hybrid variable, and discarding retained hybrid variables that do not meet a discriminatory strength statistic decision criteria.

In some embodiments the processor is further caused to sort the retained hybrid variables based on at least one of the discriminatory strength statistic and the predicted lift likelihood value.

In some embodiments sampling at least one hybrid variable for each sampled interaction effect structure comprises sampling so that the number of randomly selected hybrid variables for each sampled interaction effect structure is equal to a multiplicity of the total number of variables contained within the multivariable dataset.

In some embodiments sampling at least one hybrid variable for each sampled interaction effect structure comprises sampling so that the number of randomly selected hybrid variables for each sampled interaction effect structure is at least ten times the total number of variables contained within the multivariable dataset.

In some embodiments the multivariable dataset comprises dependent variables and independent variables.

In some embodiments the dependent variables are labeled variables.

In some embodiments the processor is further caused to partition the multivariable dataset based on the labeled dependent variables to create at least two partitioned datasets.

In some embodiments the processor is further caused to calculate at least one discriminatory strength statistic for each variable in the at least two partitioned datasets, and calculating at least one discriminatory strength statistic for each sampled hybrid variable.

In some embodiments the processor is further caused to select one or more variables within each hybrid variable, wherein the one or more selected variables comprises a variable with highest discriminatory strength within the hybrid variable.

In some embodiments the processor is further caused to calculate moment statistics for each variable, calculating moment statistics for each hybrid variable, and sourcing moment statistics calculated for each selected one or more variables.

In some embodiments calculated moment statics for each variable are used for algebraically calculating moment statistics for each hybrid variable by the processor.

In some embodiments the calculated moment statistics for each variable are used by the processor as a source for sourcing moment statistics of the selected one or more variables for each hybrid variable.

In some embodiments calculating moment statistics or sourcing moment statistics comprises calculating or sourcing respectively at least the first two moments.

In some embodiments the processor is further caused to create a variable moments dataset and to store the moment statistics of each variable within the variable moments dataset.

In some embodiments the processor is further caused to store a moments dataset within the memory, and to store the moment statistics of each hybrid variable alongside the moment statistics of the selected one or more variables for that hybrid variable within the dataset.

In some embodiments the processor is further caused to store a categorical variable alongside each hybrid variable.

In some embodiments the categorical variable indicates one or more operators of the associated hybrid variable.

In some embodiments the processor is further caused to calculate a discriminatory measure statistic for each sampled hybrid variable.

In some embodiments calculating a lift value for each sampled hybrid variable comprises dividing the discriminatory measure statistic of the sampled hybrid variable by the discriminatory strength statistic of the variable having the highest discriminatory strength within the hybrid variable.

In some embodiments training the machine learning model to predict the likelihood of a hybrid variable having a lift which exceeds the lift threshold comprises creating a training dataset by combining the labeled sampled hybrid variables with the moments dataset by matching the hybrid variables across the datasets.

Some embodiments relate to a method for selecting hybrid variables, the method comprising:
sampling at least one interaction effect structure of at least one multivariable dataset;
applying a trained machine learning model to each hybrid variable within each sampled interaction effect structure to determine a value corresponding to the likelihood of each hybrid variable having a lift which exceeds the threshold lift criteria, wherein the trained machine learning model was trained using a dataset containing moments of sampled hybrid variables, moments of selected variables of the sampled hybrid variables, and labels indicating whether each of the sampled hybrid variables has sufficient lift according to the threshold lift criteria; and
retaining only hybrid variables with a likelihood value that exceeds a decision criteria.

In some embodiments the trained machine learning model is trained using labeled sampled hybrid variables that have been obtained by:
sampling at least one hybrid variable for each sampled interaction effect structure;
calculating a lift value for each sampled hybrid variable, and comparing the lift value to a threshold lift criteria; and
generating the labeled sampled hybrid variables by labeling each sampled hybrid variable based on determining if the lift value of the sample hybrid variable exceeds the threshold lift criteria.

Some embodiments relate to a method for generating a machine learning model for predicting rainfall in a region within a predetermined time period, the method comprising: sampling at least one interaction effect structure of at least one multivariable dataset; sampling at least one hybrid variable for each sampled interaction effect structure; calculating a lift value for each sampled hybrid variable, and comparing the lift value to a threshold lift criteria; labeling each sampled hybrid variable based on determining that the lift value of the sample hybrid variable exceeds the threshold lift criteria; training a machine learning model to predict the likelihood of a hybrid variable having a lift which exceeds the threshold lift criteria, the training being performed using the labeled sampled hybrid variables; applying the trained machine learning model to each hybrid variable within each sampled interaction effect structure to determine a value corresponding to the likelihood of each hybrid variable having a lift which exceeds the threshold lift criteria; retaining only hybrid variables with a likelihood value that exceeds a decision criteria; and using at least one of the retained hybrid variables for generating a second machine learning model to determine probability of rainfall in the region within the predetermined dataset; wherein the multivariable dataset contains data received from one or more sensors, the data received from the one or more sensors including data pertaining to weather measurements.

Some embodiments relate to a method for generating a machine learning model for predicting default of one or more repayment obligations, the method comprising: sampling at least one interaction effect structure of at least one multivariable dataset; sampling at least one hybrid variable for each sampled interaction effect structure; calculating a lift value for each sampled hybrid variable, and comparing the lift value to a threshold lift criteria; labeling each sampled hybrid variable based on determining that the lift value of the sample hybrid variable exceeds the threshold lift criteria; training a machine learning model to predict the likelihood of a hybrid variable having a lift which exceeds the threshold lift criteria, the training being performed using the labeled sampled hybrid variables; applying the trained machine learning model to each hybrid variable within each sampled interaction effect structure to determine a value corresponding to the likelihood of each hybrid variable having a lift which exceeds the threshold lift criteria; retaining only hybrid variables with a likelihood value that exceeds a decision criteria; and using at least one of the retained hybrid variables for generating a second machine learning model to predict default of one or more repayment obligations; wherein the multivariable dataset contains data of one or more financial participants, the data of the one or more financial participants including data pertaining to repayment history.

Some embodiments relate to a method for generating a machine learning model, the method comprising: sampling at least one interaction effect structure of at least one multivariable dataset; sampling at least one hybrid variable for each sampled interaction effect structure; calculating a lift value for each sampled hybrid variable, and comparing the lift value to a threshold lift criteria; labeling each sampled hybrid variable based on determining that the lift value of the sample hybrid variable exceeds the threshold lift criteria; training a machine learning model to predict the likelihood of a hybrid variable having a lift which exceeds the threshold lift criteria, the training being performed using the labeled sampled hybrid variables; applying the trained machine learning model to each hybrid variable within each sampled interaction effect structure to determine a value corresponding to the likelihood of each hybrid variable having a lift which exceeds the threshold lift criteria; retaining only hybrid variables with a likelihood value that exceeds a decision criteria; and using at least one of the retained hybrid variables for generating a second machine learning model.

The steps, features, integers, compositions and/or compounds disclosed herein or indicated in the specification of this application individually or collectively, and any and all combinations of two or more of said steps or features.

### BRIEF DESCRIPTION OF THE DRAWINGS

FIG. 1 is a block diagram of computing components of a system for conditioning data according to some embodiments;

FIG. 2 is a flow diagram illustrating a method of use of the system of FIG. 1;

FIG. 3 is a flow diagram illustrating a method of use of the system of FIG. 1 showing the resulting data sets;

FIG. 4 is a flow diagram illustrating a method of use of the system of FIG. 1, showing sub processes of a process from FIG. 2 in further detail;

FIG. 5 shows a table corresponding to a dataset that may be processed by the system of FIG. 1 in some embodiments;

FIG. 6 shows a table corresponding to a dataset that may be generated by the system of FIG. 1 in some embodiments;

FIG. 7 shows a table corresponding to a further dataset that may be generated by the system of FIG. 1 in some embodiments;

FIG. 8 shows two tables corresponding to two further datasets that may be generated by the system of FIG. 1 in some embodiments; and

FIG. 9 shows two tables corresponding to two further example datasets that may be generated by the system of FIG. 1 in some embodiments.

### DETAILED DESCRIPTION

Described embodiments generally relate to methods and systems for conditioning datasets for computational processing. In particular, described embodiments relate to dataset conditioning which leads to developing supervised classification machine learning models.

Specifically, described embodiments relate to methods, devices and systems for hybrid variable feature selection, which leads to developing supervised classification machine learning models efficiently.

Examples of supervised classification machine learning models include logistic regression, feed forward neural networks, and tree ensembles, but are not limited thereto.

Contextual examples for use of described embodiments include datasets and developing models for determining probability of default, probability of making an insurance claim, forecasting weather patterns, predicting viral contraction, ecological modeling and industrial systems modeling, but are not limited thereto.

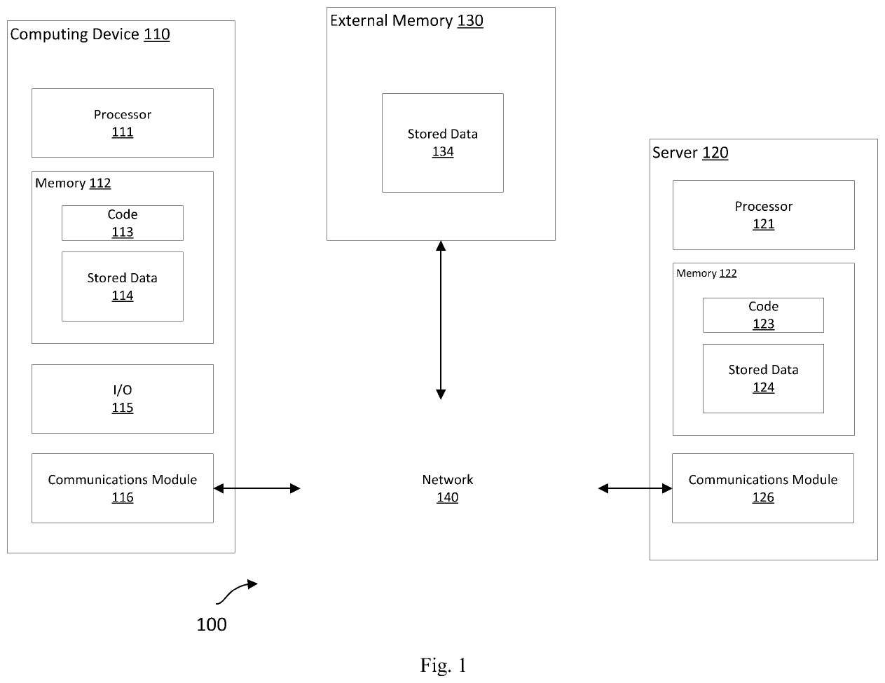

FIG. 1 shows an example system 100 for selection of hybrid variables for discrimination modeling. For example, system 100 may be used to select hybrid variables for discrimination modeling that may be used for weather condition prediction on a particular day in a region according to some embodiments. According to some other embodiments, the system 100 for selection of hybrid variables for discrimination modeling may be used for predicting default of one or more repayment obligations. According to some other embodiments, system 100 may be used to determine or predict other real-world parameters or values, based on existing datasets relating to those parameters or values.

According to some embodiments, system 100 may be used for an optimization method to select hybrid variables for discrimination modeling. Hybrid variables are selected on the constraint of acceptable discrimination statistic values and lift values in relation to the user's defined threshold criteria.

System 100 includes a computing device 110. Computing device 110 may be a laptop, desktop or other computing device. Computing device 110 comprises a processor 111 and memory 112. Processor 111 may comprise one or more microprocessors, central processing units (CPUs), application specific instruction set processors (ASIPs), or other processors capable of reading and executing instruction code.

Memory 112 may comprise one or more volatile or non-volatile memory types, such as RAM, ROM, EEPROM, or flash, for example. Memory 112 may be configured to store code 113 and data 114. Processor 111 may be configured to access memory 112 to read and execute code 113 stored in memory 112, to read and load stored data 114, and to perform processes specified in code 113 to process stored data 114.

Computing device 110 may further comprise user input and output 115, and communications module 116. Communications module 116 may facilitate communication via a wired communication protocol, such as USB or Ethernet, or via a wireless communication protocol, such as Wi-Fi, Bluetooth or NFC, for example. Processor 111 may be configured to communicate with user input and output 115, and communications module 116.

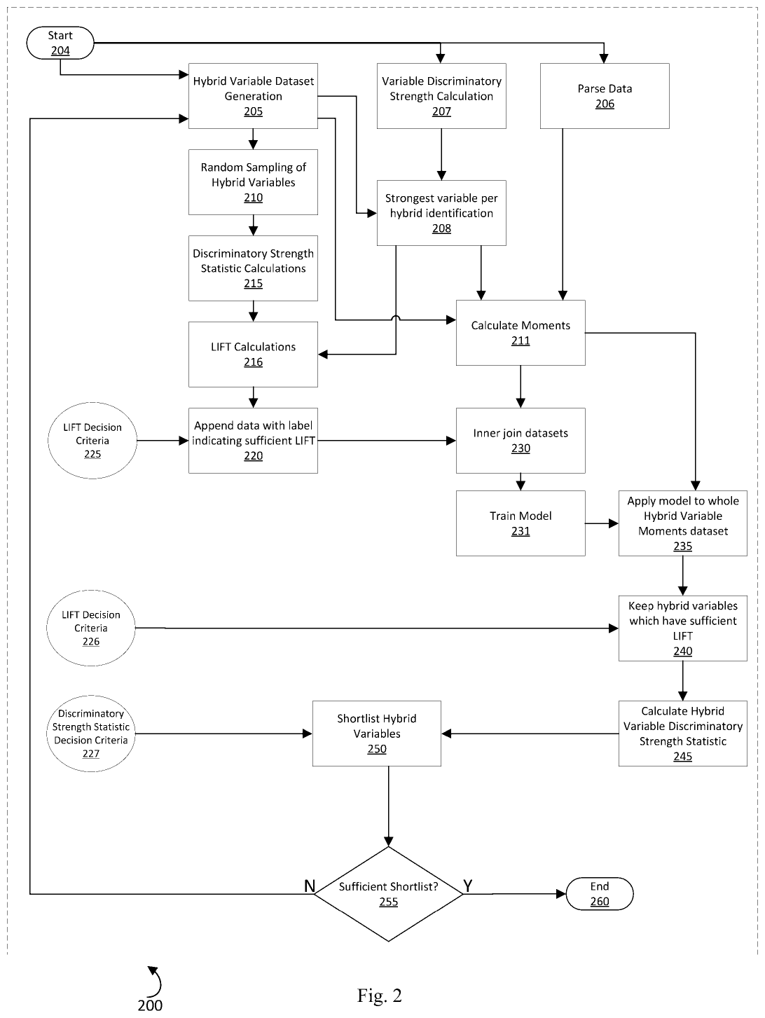

User input and output 115 may comprise one or more of an output display screen, an input mouse, an input keyboard or other I/O devices. In some embodiments the input function of user input and output 115 may be used to facilitate or perform steps within method 200 as described below with reference to FIG. 2, such as lift decision criteria step 225 and GINI decision criteria step 226.

System 100 further comprises network 120, a server 120 and external memory 130. Computing device 110 may be configured to use communications module 116 to communicate via network 140 to external or remote devices, such as external memory 130 or server 120.

Network 140 may comprise direct connections between hosts, enterprise networks, Internet, local area networks or any other networks both wired or wireless.

External memory 130 may comprise one or more of flash memory, external hard drives, cloud storage or any other data storage medium external to computing device 110.

Server 120 may be a single server, a service system, a cloud-based server or server system, or other computing device providing centralised servers to computing devices such as computing device 110. Server 120 comprises processor 121, and memory 122 accessible to processor 121. Server 120 is capable of storing code 123 and data 124 in memory 122. Processor 121 may be configured to read and execute code 123 to load stored data 124, and perform processes specified in code 123 to process stored data 124.

Server 120 further comprises a communications module 126. Communications module 126 may facilitate communication between server 120 and other devices via a wired communication protocol, such as USB or Ethernet, or via a wireless communication protocol, such as Wi-Fi, Bluetooth or NFC, for example.

FIG. 2 shows a method 200 of selecting hybrid variables for classification models as performed by system 100. According to some embodiments, method 200 may be configured to select optimal hybrid variables for classification models. For example, where system 100 is used for weather condition prediction on a particular day in a region, method 200 may be configured to select optimal hybrid variables for producing a classification model to predict a weather condition based on historical weather data. Where system 100 is used for prediction of default of one or more repayment obligations by a recipient of a loan, method 200 may be configured to select optimal hybrid variables for producing classification models to predict default of the one or more repayment obligations based on the recipient's previous loan repayment history.

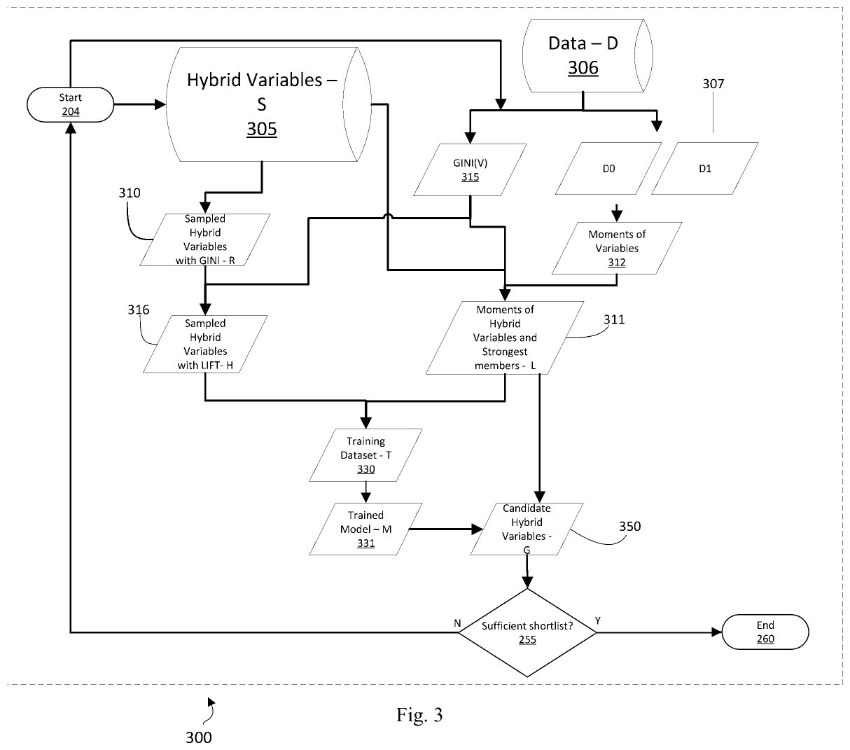

Method 200 begins with step 204, at which processor 111 is provided with an initial dataset, which may be dataset D 306 as described below with reference to FIG. 3. The initial dataset 306 provided to processor 111 may contain data for one or more independent variables and one or more dependent variables. In some embodiments, the one or more dependent variables from dataset 306 may be the target variables for a classification model.

Where system 100 is used for weather prediction, the one or more independent variables may comprise a rainfall prediction on a day in the region, for example. In some embodiments the one or more dependent variables may then comprise measurements from sensors of temperature, humidity, and precipitation, at different sites both within and outside the region, and at different points in time.

Where system 100 is used to predict default of a repayment obligation, the one or more independent variables may comprise a default prediction of one or more of the repayment obligations. In such embodiments, the one or more dependent variables may comprise data pertaining to the one or more financial participants' past repayment history of repayment obligations, assets of the one or more financial participants, and liabilities of the one or more financial participants.

In some embodiments, the dependent variables from dataset 306 may be labeled variables. In some embodiments, the size of memory 122 and/or external memory 130 may be selected to accommodate the processing of dataset 306 in method 200. For example, a memory 122 of a size of at least 16 GB may be selected to accommodate processing method 200 when dataset 306 is of a size of approximately 2 GB. According to some alternative embodiments, a memory 122 of a size of at least 5 GB, 10 GB, 15 GB or 20 GB may be selected. According to some embodiments, a memory 122 of a size of larger than 20 GB may be selected.

Once dataset 306 is made available to processor 111, processor 111 begins to execute steps 205, 206 and 207. According to some embodiments, these steps may be performed sequentially. According to some embodiments, these steps may be performed simultaneously.

At step 206, processor 111 executing code 113 is caused to partition the data from the dataset 306. This may comprise partitioning dataset 306 on the dependent variable label to create two or more partitioned datasets, such as datasets 307 as described in further detail below with reference to FIG. 3.

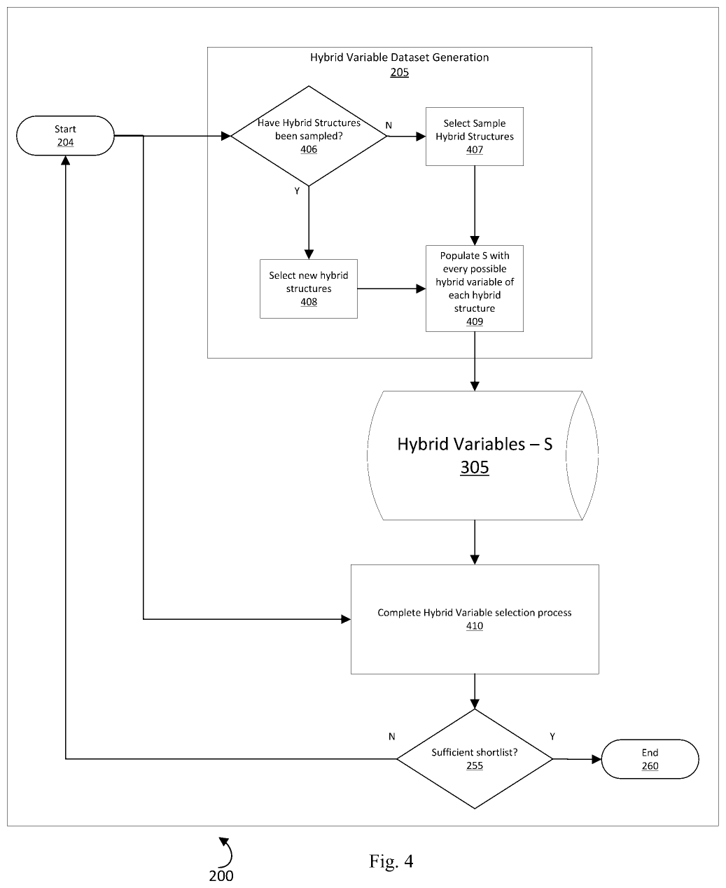

Simultaneously, subsequently or previously to step 206, processor 111 executing code 113 is caused to generate a hybrid variable dataset at step 205. The hybrid variable dataset may be hybrid variable dataset S 305, as described below with reference to FIG. 3. Hybrid variable dataset generation step 205 is described in further detail below with reference to FIG. 4. In FIG. 4, hybrid variable dataset generation step 205 comprises decision 406, and process steps 407, 408, and 409.

Simultaneously, subsequently or previously to step 206 and step 205, processor 111 executing code 113 at step 207 is caused to calculate the discriminatory strength statistics of the variables in dataset 306. Variable discriminatory strength calculation step 207 may comprise processor 111 calculating the discriminatory strength statistics, such as the GINI coefficient, for all variables in the dataset. Processor 111 performing variable discriminatory strength calculation step 207 generates discriminatory strength statistics, and records these to a discriminatory strength dataset to be stored in memory 112. The discriminatory strength dataset may be dataset GINI(V) 315 as described below with reference to FIG. 3, for example.

After performance of steps 205 and 207, processor 111 executing code 113 is caused to identify the strongest variable per hybrid variable at step 208. When executing step 208, for each variable within each hybrid variable identified in hybrid variable dataset 305, processor 111 checks for the variable's discriminatory strength by referring to dataset 315. For each hybrid variable, processor 111 selects one or more variables, which comprise the identified variable with the highest discriminatory strength for further processing. . In some embodiments the one or more selected variables further comprise another one or more variables belonging to the hybrid variable.

Having completed step 208, processor 111 executing code 113 then calculates moment statistics of all variables in dataset 306 and subsequently moment statistics of all hybrid variables in hybrid variable dataset 305 at step 211. According to some embodiments, processor 111 also uses the data of the two or more partitioned datasets 307 to calculate the moment statistics of variables and hybrid variables.

According to some embodiments, processor 111 performing step 211 also calculates the moment statistics for all variables prior to step 211 and after step 206, without dependency on the prior completion of steps 205, 207 or 208.

According to some embodiments, processor 111 performing step 211 also uses the hybrid variable structure and moment statistics of the corresponding variables as a basis for algebraically calculating hybrid variable moment statistics.

According to some embodiments, processor 111 performing step 211 also places the moment statistics of the variables into a new dataset Moments of Variables 312, as described below with reference to FIG. 3.

In some embodiments, processor 111 performing step 211 also, for each hybrid variable, refers to the one or more selected variables identified at step 208. Processor 111 then also refers to the moment statistics for all variables in order to source moment statistics to the one or more selected variables for each hybrid variable.

In some embodiments, processor 111 performing step 211 also calculates the moment statistics of all variables as being the first two or more moments of the variables. In some embodiments, processor 111 calculates the hybrid variable moment statistics as being the first two or more moments of the hybrid variables in dataset 305. In some embodiments, processor 111 determines the strongest variable moment statistics as being the first two or more moments of the strongest variables for each hybrid variable in dataset 305.

According to some embodiments, processor 111 may store the calculated hybrid variable moments and the associated strongest variable moments determined at steps 208 and 211 within a single line entry of a dataset, which may be dataset L 311 in some embodiments, as described below in further detail with reference to FIG. 3. In some embodiments, processor 111 may also store a categorical variable within each line entry in dataset 311. The categorical variable may indicate the one or more operators of the hybrid variable in the line entry. The categorical variable may also be called the operator variable. In some embodiments, the operator variable may comprise a string variable, a numerical variable, or may be one hot encoded as multiple indicator variables.

Subsequent to performing step 205, processor 111 executing code 113 randomly samples the hybrid variables of dataset 305 at step 210. In some embodiments, processor 111 may be configured to sample each hybrid structure within the hybrid variable dataset 305.

In some embodiments, processor 111 may be configured to select a number of hybrid variables so that the number of randomly selected hybrid variables for a given hybrid structure is equal to a multiplicity of the total number of variables contained within the dataset 306, as described in further detail below with reference to FIG. 3. In some embodiments, processor 111 may be configured to select a number of hybrid variables so that the number of randomly selected hybrid variables for a given hybrid structure is equal to approximately ten times the total number of variables contained within data 306. In some embodiments, processor 111 may be configured to select a number of hybrid variables so that the number of randomly selected hybrid variables for a given hybrid structure is at least ten times the total number of variables contained within data 306.

Having performed step 210, processor 111 executing code 113 is caused to calculate a discriminatory measure statistic, such as a GINI coefficient, for each of the randomly selected hybrid variables selected during step 210.

In some embodiments, processor 111 may place the randomly selected hybrid variables from step 210 and their associated discriminatory strength statistics as calculated during step 215 in a data set of sampled hybrid variables, which may be dataset R 310 as described below with reference to FIG. 3.

In some embodiments, during step 215, processor 111 also associates the random sample of hybrid variables identified at step 210 with their respective strongest variable as identified from the results of step 208.

After performing steps 208 and 215, processor 111 executing code 113 executes step 216. At step 216, processor 111 calculates lift for each randomly sampled hybrid variable identified at step 210. In some embodiments, the lift calculation of each randomly sampled hybrid variable comprises processor 111 dividing the discriminatory strength statistic of the hybrid variable as calculated at step 215 by the discriminatory strength statistic of the strongest variable within the hybrid variable as calculated in at step 207 and identified at step 208.

In some embodiments, processor 111 may record the lift calculations from step 216 within a new intermediate dataset of sampled hybrid variables, which may be dataset H 316 as described below with reference to FIG. 3. Processor 111 may also store the associated hybrid variable with each lift value.

At step 225, processor 111 sets a lift decision criteria. In some embodiments, the lift decision criteria comprises a threshold value upon which lift values can be compared to.

After steps 216, and 225 have been performed, processor 111 may be configured to perform step 220 by appending stored dataset 316 with labels indicating whether each stored hybrid variable has a sufficient lift value. Processor 111 may perform step 220 by appending the line entries of dataset 316 with indicator data for a new indicator variable which indicates whether or not the lift values of each hybrid variable calculated in step 216 exceed the lift threshold set during step 225. In some embodiments, processor 111 may set the indicator variable of hybrid variables which have lift which exceeds the lift threshold to a value of “1”, and may set hybrid variables which have lift which does not exceed the lift threshold to a value of “0”.

In some embodiments, processor 111 performing step 220 may create a new dataset rather than appending the dataset.

Having performed steps 220 and 211, processor 111 executing code 113 may be configured to perform step 230 by inner joining dataset 316 with dataset 311. Processor 111 may inner join dataset 316 with dataset 311 to create a training dataset, which may be dataset T 330 as described in further detail below with reference to FIG. 3. According to some embodiments, processor 111 may perform the joining of the datasets by matching the hybrid variables across the datasets. In some embodiments, processor 111 may change the operator variable of dataset 311 or resulting dataset 330 to one hot encoded.

Having performed step 230, processor 111 executing code 113 then performs step 231 to train a model. In some embodiments, processor 111 performing step 231 uses machine learning methods to train a model to predict the likelihood of a hybrid variable having a lift which exceeds the lift threshold set during step 225. The trained model may be model M 331, as described in further detail below with reference to FIG. 3. In some embodiments, the dependent variable is the indicator variable generated by processor 111 at step 220. In some embodiments, the independent variables are the moments and the operator variable calculated by processor 111 at step 211.

According to some embodiments the appropriate parameters for training the model M 331 should be determined from rigorous hyper parameter tuning. According to some embodiments the model M 331 is a tree ensemble. According to some embodiments the tree ensemble is learned by Gradient Boosted Trees.

According to some embodiments, wherein the model M 331 is a tree ensemble, an ensemble of approximately 80 trees with trees of depth 4 to 5 may yield effective results when dataset 306 comprises approximately 650 variables and approximately 2 million rows. According to some embodiments, such a dataset may have a file size of around 11 GB. In some embodiments, dataset 306 may be of a different size, such as around 2 GB, or between 1 GB and 20 GB, for example. In particular, the described method may be advantageous where the size of dataset 306 creates runtime issues due to the length of time it takes to create the variables for that dataset.

However, according to some other embodiments, model M 331 and dataset 306 is not limited thereto. For example, where model M 331 is a tree ensemble, an ensemble of up to 50, 100, 150, 200 or more trees may be used. According to some embodiments, the trees may have a depth of 1, 2, 3, 4, 5, 6, 7, 8, 9, 10 or more.

Dataset 306 may comprise any number of variables. In some embodiments, dataset 306 may comprise at least 500, 1000, 1500, 2000 or more variables. According to some embodiments, dataset 306 may comprise any number of rows. According to some embodiments, dataset 306 may comprise between 1 million and 5 million rows. According to some embodiments, dataset 306 may comprise more than 5 million rows. According to some other embodiments the Model M 331 is not a tree ensemble, but another type of model learned by machine learning methods. According to some embodiments, Model M 331 is any type of model learned by machine learning methods.

Having completed steps 231 and 211, processor 111 executing code 113 performs step 235, at which processor 111 applies model 331 to dataset 311. In some embodiments, processor 111 performing step 235 applies model 331 as calculated at step 231 to each line entry within dataset 311 in order to predict the likelihood of each hybrid variable stored in dataset 311 having a lift which exceeds the lift threshold set at step 225. In some embodiments, model 331 is chosen from a previous method 200 iteration or from other sources. For example, model 331 may be retrieved from a database. In embodiments where model 331 has been previously generated and retrieved, step 235 is not dependent on completion of step 231. Rather, processor 111 performs step 235 after completion of step 211.

At step 226, processor 111 sets a lift decision criteria. In some embodiments, the lift decision criteria comprises a threshold value that lift values can be compared to. In some embodiments, the criteria determined at step 226 has the same value as the criteria determined at step 225. In alternative embodiments, the criteria determined at step 226 has a different value to the criteria determined at step 225.

After performing steps 235 and 226, processor 111 executing code 113 performs step 240. At step 240, processor 111 compares the predicted likelihood values determined at step 231 to the decision criteria set at step 226, and retains only the hybrid variables whose predicted likelihood values exceed the decision criteria determined at step 226. The retained variables are stored in a dataset candidate hybrid variable dataset, such as dataset G 350, described in further detail below with reference to FIG. 3.

Having executed step 240, processor 111 executing code 113 performs step 245 to calculate hybrid variable discriminatory strength statistics. In some embodiments, processor 111 performing step 245 calculates a discriminatory strength statistic, such as such as a GINI coefficient, for each hybrid variable within dataset 350, and appends the calculated discriminatory strength statistic to the line entry of the associated hybrid variable in dataset 350.

At step 227, processor 111 sets a discriminatory strength statistic decision criteria. In some embodiments, the discriminatory strength statistic decision criteria set at step 227 comprises a threshold value which the corresponding discriminatory strength statistic can be compared to.

Having performed steps 245 and 227, processor 111 executing code 113 shortlists hybrid variables at step 250. In some embodiments, processor 111 performing step 250 compares the hybrid variable discriminatory strength statistics calculated at step 245 to the discriminatory strength statistic criteria set at step 227. In some embodiments, processor 111 performing step 250 proceeds with one or more methods of manipulating the hybrid variable line entries of dataset 350. In particular, processor 111 may manipulate the hybrid variable line entries of dataset 350 by one or more of:
Removal of hybrid variables line entries from dataset 350 if their discriminatory strength does not exceed the discriminatory strength criteria threshold set at step 227;
Sorting of hybrid variables line entries from dataset 350 by discriminatory strength;
Sorting of hybrid variables line entries from dataset 350 by predicted lift likelihood values; and
Sorting of hybrid variables line entries from dataset 350 by discriminatory strength and predicted lift likelihood values.

Having performed step 250, processor 111 performs a decision step at step 255. Performing decision step 255 comprises processor 111 determining if there is a sufficient shortlist of valid hybrid variable line entries from dataset 350 for the selection of the shortlisted hybrid variables for classification modeling to predict the target variable. According to some embodiments, processor 111 may determine that there is a sufficient shortlist of valid hybrid variable line entries from dataset 350 if the number of valid hybrid variable line entries from dataset 350 exceeds a predetermined threshold. If the shortlist of valid hybrid variable line entries from dataset 350 is deemed sufficient, processor 111 proceeds to end step 260, which concludes the performance of method 200. At step 260, the shortlisted hybrid variables from dataset 350 are selected and/or retained for classification modeling of the data 306. In some other embodiments the shortlisted hybrid variables from dataset 350 are selected and/or retained for classification modeling of some other dataset, or a combination of the other dataset with some or all of the data 306. If the shortlist of valid hybrid variable line entries from dataset 350 is deemed insufficient, processor 111 proceeds to continue executing method 200 from step 205, whereby a new selection of hybrid variable structures and consequent generation of hybrid variables are made and used to populate dataset 305, and the hybrid variable feature selection method reiterates.

According to some embodiments, an example shortlisted hybrid variable may be a temperature measurement from a first sensor at time 6 hours before the day at a first site, multiplied by a precipitation measurement from a second sensor at time 6 hours before the day at the first site. According to some other embodiments an example shortlisted hybrid variable may be current assets of a financial participant, divided by current liabilities of the financial participant.

Classification modeling of the data 306 may comprise using some or all of the shortlisted hybrid variables, and some or all of the variables, to train a second machine learning model, which may be referred to as the machine learning model. In some embodiments the machine learning model may be a supervised classification learning model. In some embodiments the machine learning model may be a logistic regression model, a feed forward neural network, or a tree ensemble.

In some other embodiments classification modeling may comprise using some other dataset, or a combination of the other dataset with some or all of the data 306.

According to some embodiments the machine learning model's discrimination ability may be improved by using method 200. According to some embodiments, the machine learning model's discrimination ability may have significant improvement wherein the machine learning model is a logistic regression model.

Contextual examples for use of the machine learning model include determining probability of default, probability of making an insurance claim, forecasting weather patterns, predicting viral contraction, ecological modeling and industrial systems modeling. Specifically, the machine learning model trained with the shortlisted hybrid variables produced by method 200 may be used to process datasets, and make predictions based on the data contained in the dataset. For example, a machine learning model trained with a selection of shortlisted hybrid variables produced by method 200 based on a dataset relating to weather condition data may be configured to predict future weather patterns based on new weather sensor data.

FIG. 3 shows a method 300 of selecting hybrid variables for classification models as performed by system 100. Method 300 is similar to method 200, but shows the method in terms of the data and models rather than the process steps.

Method 300 starts with processor 111 performing step 204, as described above with reference to FIG. 2. At step 204, a dataset D 306 is obtained by processor 111. Dataset 306 contains data for at least one independent variable and at least one dependent variable. In some embodiments, the dependent variables from dataset 306 are the target variables for a classification model. In some embodiments, the dependent variable from dataset 306 is a labeled variable.

Having performed step 204, processor 111 generates two or more partitioned datasets 307. The two or more datasets 307 are generated by processor 111 performing step 206 as described above with reference to FIG. 2.

Processor 111 also generates the dataset GINI(V) 315. Dataset 315 is generated by processor 111 performing step 207 as described above with reference to FIG. 2. Dataset 315 is configured to store the variable discriminatory strength values calculated by processor 111.

Processor 111 also generates dataset S 305. Dataset 305 is generated by processor 111 performing step 205 as described above with reference to FIG. 2. Dataset 305 is configured to store the hybrid variable data generated by processor 111. According to some embodiments, each of the hybrid variables within dataset 305 comprises at least one mathematical operator and at least two operands. According to some embodiments the at least two operands of the hybrid variables within dataset 305 each comprise a variable from the multivariable dataset 306. According to some embodiments each of the hybrid variables within dataset 305 comprises an arithmetic operator or mathematical function.

Processor 111 also generates dataset R 310. Dataset 310 is generated by processor 111 performing steps 210 and 215 as described above with references to FIG. 2. Dataset 310 is configured to store the hybrid variable GINI values calculated by processor 111.

Processor 111 also generates dataset H 316. Dataset 316 is generated by processor 111 performing steps 208 and 216 as described above with reference to FIG. 2. Dataset 316 is configured to store the sampled hybrid variables with lift values calculated by processor 111.

Processor 111 also generates dataset 312. Dataset 312 is generated by processor 111 performing step 211 as described above with reference to FIG. 2. Dataset 312 is configured to store the moments of the variables as determined by processor 111.

Processor 111 also generates dataset L 311. Dataset 311 is generated by processor 111 performing steps 208 and 211 as described above with reference to FIG. 2. Dataset 311 is configured to store the moments of the hybrid variables and the strongest members as determined by processor 111.

Processor 111 also generates dataset T 330. Dataset 330 is generated by processor 111 performing steps 225, 220 and 230 as described above with reference to FIG. 2. Dataset 330 is configured to store the training data determined by processor 111.

Processor 111 also generates training model 331. Model 331 is generated by processor 111 performing step 231 as described above with reference to FIG. 2.

Processor 111 also generates dataset G 350. Dataset 350 is generated by processor 111 performing steps 226, 227, 235, 240, 245, and 250 as described above with reference to FIG. 2. Dataset 350 is configured to store candidate hybrid variables determined by processor 111.

Having generated dataset 350, processor 111 executing method 300 performs decision step 255, as described above with reference to FIG. 2. Where processor 111 determines that a sufficient shortlist of hybrid variables exist, processor proceeds to execute end step 260 as described above with references to FIG. 2. Where processor 111 determines that an insufficient shortlist of hybrid variables exists, processor proceeds to recommence executing method 300 at step 205, to recreate dataset 305 to repeat the methods 200 and 300 of hybrid variable selection.

FIG. 4 describes method 200, and particularly step 205, of FIG. 2 in further detail.

Processor 111 executing method 200 begins by executing step 204, as described above with reference to FIG. 2. Having performed step 204, processor 111 proceeds to perform step 205. As shown in FIG. 4, step 205 comprises decision step 406, and process steps 407, 408, and 409.

At step 406, processor 111 determines whether hybrid structures have already been sampled. If hybrid structures have not been sampled, processor 111 carries out the selection of some sample hybrid structures by performing step 407. At step 407, processor 111selects hybrid structures to sample. According to some embodiments each of the hybrid structures comprises at least one mathematical operator and at least two operands. According to some embodiments, the at least one operator of the hybrid structures comprises an arithmetic operator or mathematical function. According to some embodiments a hybrid structure is an interaction effect structure.

After processor 111 finished step 407, processor 111 proceeds to perform method 200 from step 409.

If at decision step 406 processor 111 determines that hybrid structures have already been sampled, processor 111 carries out the selection of some new hybrid structures at step 408. After processor 111 has finished performing step 408 concludes, processor 111 proceeds to perform method 200 from step 409.

After completing step 407 or step 408, processor 111 performs step 409, by populating dataset S 305 with every possible hybrid variable of each hybrid structure. This may comprise processor 111 populating dataset 305 as described above with reference to FIG. 3 with every possible hybrid variable of each hybrid structure selected by processor 111 in either step 407 or 408.

Having performed step 205, processor 111 generates dataset S 305, and continues to execute method 200 by performing step 410, which may comprise all of steps 206, 207, 208, 210, 211, 215, 216, 220, 225, 226, 227, 230, 231, 235, 240 and 245, as described above with reference to FIGS. 2 and 3.

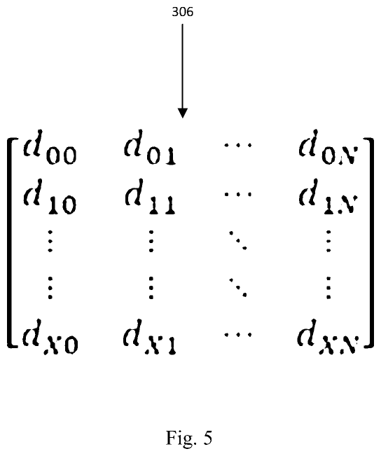

FIG. 5 shows dataset D 306, as described above and shown in FIG. 3, in further detail. The dataset 306 is shown as a matrix or rectangle array which contains the data used for modeling. The rows of the matrix may represent separate observations of data. In the illustrated embodiment, that dataset 306 contains X+1 observations. The columns of the matrix represent different variables. In the illustrated embodiment, dataset 306 contains N+1 variables. Note that in FIG. 5, each data point within dataset 306 is represented by a character “d” with two subscript numbers, the first number indicating the row number (in this case the row number is the observation number) and the second number indicating the column number (in this case the column number is the variable number).

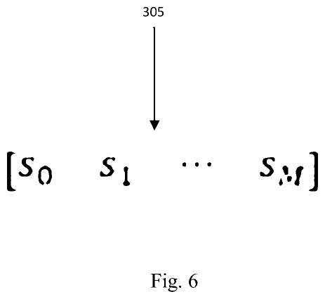

FIG. 6 shows the dataset Hybrid Variables—S 305, as described above and shown in FIG. 3, in further detail. The dataset 305 is shown as a single row vector, wherein each entry represents a Hybrid Variable. As described above, all variable combinations of each selected hybrid variable structure will be contained in dataset 305. Note that in FIG. 6, each hybrid variable is represented in the vector by a character “s” with a subscript number indicating the column number. In FIG. 6 there is a vector length of M+1 hybrid variables in dataset 305. In some embodiments, upon method 200 reiterating step 205 due to an insufficient hybrid shortlist determined in step 255, as described above and shown in FIG. 2 and FIG. 4, the length of the vector may not be M+1. Instead, the dataset 305's vector length will be dependent upon the new hybrid variable structures selected. Each entry in dataset 305 may contain information pertaining to the one or more mathematical operations used to obtain the hybrid variable and the two or more variables used within the hybrid variable. In some embodiments, dataset 305 may include further rows for storing the hybrid variable information for each hybrid variable.

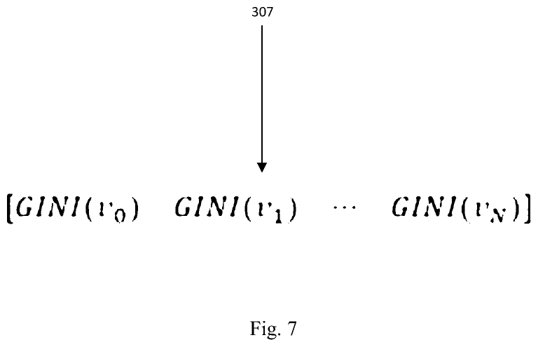

FIG. 7 shows dataset GINI(V) 315, as described above and shown in FIG. 3, in further detail. In FIG. 7, dataset 315 is shown as a row vector. Each entry in dataset 315 corresponds to a calculated discriminatory measure, such as a GINI coefficient, for each variable in the dataset D 306. FIG. 7 shows each column entry with the characters GINI representing a GINI function, followed by parentheses which contain the variable used to perform the calculation. FIG. 7 shows the variable contained within parentheses represented by a character “v” with a subscript number representing a column number. The dataset 306 shown in FIG. 5 can be viewed as appropriate dimensions for being the source data for generating the dataset 315 shown in FIG. 7, due to both datasets containing N+1 variables.

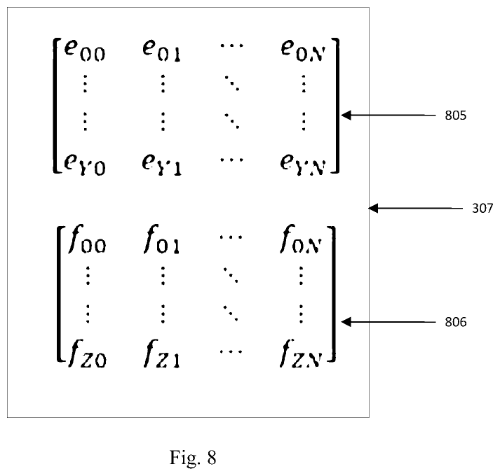

FIG. 8 shows the two or more partitioned datasets 307, wherein there are two datasets represented by matrices, which have been partitioned from dataset 306 shown in FIG. 5. In FIG. 8, the two or more datasets 307 comprise a first partitioned dataset D1 805 and a second partitioned dataset D0 806. Dataset 805 contains data of the observations from dataset 306 which contain a value of “1” for a target variable label, and dataset 806 contains data of the observations from dataset 306 which contain a value of “0” for a target variable label.

Dataset 805 contains rows of the matrix which may represent separate observations of data. In the illustrated embodiment, dataset 805 contains Y+1 observations, where Y+1 should be less than the X+1 rows seen in dataset 306. The columns of dataset 805 represent different variables. In the illustrated embodiment, dataset 805 contains N+1 variables, as does dataset 306. Note that in FIG. 8, each data point within dataset 805 is represented by a character “e” with two subscript numbers, the first number indicating the row number (in this case the row number is the observation number) and the second number indicating the column number (in this case the column number is the variable number).

Dataset 806 contain rows of the matrix which may represent separate observations of data. In the illustrated embodiment, dataset 806 contains Z+1 observations, where Z+1 should be less than the Z+1 rows seen in dataset 306. The columns of dataset 806 represent different variables. In the illustrated embodiment, dataset 806 contains N+1 variables, as does dataset 306. Note that in FIG. 8, each data point within dataset 806 is represented by a character “f” with two subscript numbers, the first number indicating the row number (in this case the row number is the observation number) and the second number indicating the column number (in this case the column number is the variable number).

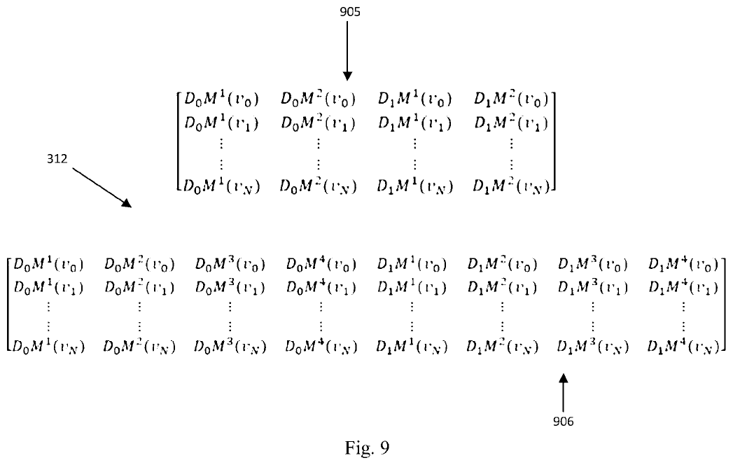

FIG. 9 shows datasets 905 and 906. Dataset 905 and dataset 906 are shown to contain rows which represent different variables, while the columns represent different moment calculations. Each entry in dataset 905 and dataset 906 are represented with a “D” followed by a superscript number whereby if the subscript number is a “0” the moment statistic was calculated based on dataset 806, and if the subscript number is a “1” the moment statistic was calculated based on dataset 805.

Each entry in datasets 905 and 906 are represented also with an M followed by a superscript number, whereby the superscript number corresponds to the Moment ordinal. Each entry in datasets 905 and 906 are represented also with a parentheses containing a v followed by a subscript number, indicating the variable being calculated. Note that in FIG. 9, datasets 905 and 906 contain N+1 number of rows which corresponds to the N+1 number of columns in FIG. 5's representation of the dataset 306.

FIG. 9 shows two different examples of the dataset Moments of Variables 312, wherein dataset 905 represents dataset 312 when it contains the first two moments, and dataset 906 represents dataset 312 when it contains the first four moments.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1-2. (canceled)

3. A method for generating a machine learning model, the method comprising:
sampling at least one interaction effect structure of at least one multivariable dataset;
sampling at least one hybrid variable for each sampled interaction effect structure;
calculating a lift value for each sampled hybrid variable, and comparing the lift value to a threshold lift criteria;
labeling each sampled hybrid variable based on determining that the lift value of the sample hybrid variable exceeds the threshold lift criteria;
training a machine learning model to predict the likelihood of a hybrid variable having a lift which exceeds the threshold lift criteria, the training being performed using the labeled sampled hybrid variables;
applying the trained machine learning model to each hybrid variable within each sampled interaction effect structure to determine a value corresponding to the likelihood of each hybrid variable having a lift which exceeds the threshold lift criteria; and
retaining only hybrid variables with a likelihood value that exceeds a decision criteria.

4. (canceled)

5. The method of claim 1, the method further comprising:
determining whether the number of retained hybrid variables exceeds a predetermined threshold; and
if the number of the retained hybrid variables does not exceed the predetermined threshold, sampling at least one further interaction effect structure and repeating the method.

6. The method of claim 1, further comprising calculating a discriminatory strength statistic for each of the retained hybrid variables, and discarding retained hybrid variables that do not meet a discriminatory strength statistic decision criteria.

7. (canceled)

8. The method of claim 6, further comprising sorting the retained hybrid variables based on at least one of the discriminatory strength statistic and the predicted lift likelihood value.

9. The method of claim 1, wherein sampling at least one hybrid variable for each sampled interaction effect structure comprises sampling so that the number of randomly selected hybrid variables for each sampled interaction effect structure is equal to a multiplicity of the total number of variables contained within the multivariable dataset.

10. The method of claim 9, wherein sampling at least one hybrid variable for each sampled interaction effect structure comprises sampling so that the number of randomly selected hybrid variables for each sampled interaction effect structure is at least ten times the total number of variables contained within the multivariable dataset.

11. The method of claim 1, wherein the multivariable dataset comprises dependent variables and independent variables.

12. The method of claim 11, wherein the dependent variables are labeled variables.

13. The method of claim 12, further comprising partitioning the multivariable dataset based on the labeled dependent variables to create at least two partitioned datasets.

14. The method of claim 13, further comprising calculating at least one discriminatory strength statistic for each variable in the at least two partitioned datasets, and calculating at least one discriminatory strength statistic for each sampled hybrid variable.

15. (canceled)

16. The method of claim 14, further comprising selecting one or more variables within each hybrid variable, wherein the selected one or more variables comprises a variable with highest discriminatory strength within the hybrid variable.

17. The method of claim 16, further comprising calculating moment statistics for each variable, calculating moment statistics for each hybrid variable, and sourcing moment statistics calculated for the selected one or more variables.

18. The method of claim 17, wherein calculated moment statics for each variable are used for algebraically calculating moment statistics for each hybrid variable.

19. The method of claim 17, wherein the calculated moment statistics for each variable are used as a source for sourcing moment statistics of the selected one or more variables for each hybrid variable.

20. The method of claim 1, wherein calculating moment statistics or sourcing moment statistics comprises calculating or sourcing respectively at least the first two moments.

21. The method of claim 1, further comprising creating a variable moments dataset and storing the moment statistics of each variable within the variable moments dataset.

22. The method of claim 1, further comprising creating a moments dataset and storing the moment statistics of each hybrid variable alongside the moment statistics of the selected one or more variables for the corresponding hybrid variables.

23-25. (canceled)

26. The method of claim 22, further comprising calculating a discriminatory measure statistic for each sampled hybrid variable.

27. (canceled)

28. The method of claim 22, wherein calculating a lift value for each sampled hybrid variable comprises dividing the discriminatory measure statistic of the sampled hybrid variable by the discriminatory strength statistic of the variable having the highest discriminatory strength within the hybrid variable.

29. The method of claim 22, wherein training the machine learning model to predict the likelihood of a hybrid variable having a lift which exceeds the lift threshold comprises creating a training dataset by combining the labeled sampled hybrid variables with the moments dataset by selecting only matching hybrid variables across the datasets.

30. The method of claim 1, wherein each of the at least one interaction effect structures comprises at least one mathematical operator and at least two operands.

31. The method of claim 30, wherein each of the at least one hybrid variables comprises at least one operator and at least two operands, the at least two operands of the hybrid variables each comprising a variable from the multivariable dataset.

32. The method of claim 31, wherein each of the at least one operator of the at least one interaction effect structures and the at least one hybrid variables comprises an arithmetic operator or mathematical function.

33. (canceled)

34. (canceled)

35. A system for selecting hybrid variables, the system comprising:
a processor;
memory storing program code that is accessible and executable by the processor; and
wherein, when the processor executed the program code, the processor is caused to:
sample at least one interaction effect structure of at least one multivariable dataset;
sample at least one hybrid variable for each sampled interaction effect structure;
calculate a lift value for each sampled hybrid variable, and comparing the lift value to a threshold lift criteria;
label each sampled hybrid variable based on determining that the lift value of the sample hybrid variable exceeds the threshold lift criteria;
train a machine learning model to predict the likelihood of a hybrid variable having a lift which exceeds the threshold lift criteria, the training being performed using the labeled sampled hybrid variables;
apply the trained machine learning model to each hybrid variable within each sampled interaction effect structure to determine a value corresponding to the likelihood of each hybrid variable having a lift which exceeds the threshold lift criteria; and
retain only hybrid variables with a likelihood value that exceeds a decision criteria.

36-60. (canceled)

61. The method of claim 3, further comprising:
using at least one of the retained hybrid variables for generating a second machine learning model.

62. A computer readable medium storing non-transitory instructions which, when executed by a processor, cause the processor to:
sample at least one interaction effect structure of at least one multivariable dataset;
sample at least one hybrid variable for each sampled interaction effect structure;
calculate a lift value for each sampled hybrid variable, and comparing the lift value to a threshold lift criteria;
label each sampled hybrid variable based on determining that the lift value of the sample hybrid variable exceeds the threshold lift criteria;
train a machine learning model to predict the likelihood of a hybrid variable having a lift which exceeds the threshold lift criteria, the training being performed using the labeled sampled hybrid variables;
apply the trained machine learning model to each hybrid variable within each sampled interaction effect structure to determine a value corresponding to the likelihood of each hybrid variable having a lift which exceeds the threshold lift criteria; and
retain only hybrid variables with a likelihood value that exceeds a decision criteria.
